(19) United States
(12) Patent Application Publication
(10) Pub. No.: US 2014/0362197 A1
(43) Pub. Date: Dec. 11, 2014

(54) IMAGE PROCESSING DEVICE, IMAGE PROCESSING METHOD, AND STEREOSCOPIC IMAGE DISPLAY DEVICE

(71) Applicant: KABUSHIKI KAISHA TOSHIBA, Tokyo (JP)

(72) Inventors: Yasutoyo TAKEYAMA, Kawasaki-shi (JP); Masahiro BABA, Yokohama-shi (JP)

(73) Assignee: KABUSHIKI KAISHA TOSHIBA, Tokyo (JP)

(21) Appl. No.: 14/204,415

(22) Filed: Mar. 11, 2014

(30) Foreign Application Priority Data
Jun. 11, 2013 (JP) 2013-122629

(51) Int. Cl. H04N 13/04

(52) U.S. Cl. CPC H04N 13/0402
USPC 348/54

(57) ABSTRACT

According to an embodiment, an image processing device includes a detector, a determiner, and a generator. The detector is configured to detect a real-space position of a viewer. The determiner is configured to determine a first relative position in a virtual space between the viewer and a display surface displaying a stereoscopic image based on the real-space position of the viewer, so that a particular site of the object to be displayed on the display surface faces the viewer in the virtual space. The generator is configured to generate a stereoscopic image by rendering a three-dimensional data of the object based on the first relative position.

### CROSS-REFERENCE TO RELATED APPLICATION

This application is based upon and claims the benefit of priority from Japanese Patent Application No. 2013-122629, filed on Jun. 11, 2013; the entire contents of which are incorporated herein by reference.

### FIELD

Embodiments described herein relate generally to an image processing device, an image processing method, a computer program product, and a stereoscopic image display device.

### BACKGROUND

As far as the technology for displaying stereoscopic images is concerned, methods are known in which special glasses are used to present a different picture to each eye of a viewer so as to make the viewer recognize a stereoscopic image; or methods are known in which a viewer is made to recognize a stereoscopic image without the use of special glasses. The known methods for making a viewer recognize a stereoscopic image without the use of special glasses include a twin-view method, a multi-view method, an integral imaging method (II method), and an integral videography method (IV method) (in the following explanation, the II method and the IV method are collectively referred to as the “II method”).

For example, in order to generate a stereoscopic image that is stereoscopically viewable from a plurality of viewpoints, a technology is known in which a perspective projection screen (the target of perspective projection in the virtual world) is set on the front surface of each viewpoint; and, for each viewpoint, rendering of a three-dimensional model viewable from that viewpoint is performed to generate a stereoscopic image.

However, in the conventional technology, for example, in the case when an object representing medical data is to be viewed from a certain direction, the posture from which the object is viewable happens to change depending on the viewpoint position of the viewer, and thus the object cannot be viewed from the desired direction.

If a condition is maintained in which, regardless of the viewpoint position of the viewer, the object is viewable from a particular viewpoint; then it becomes possible to view the object from the desired direction. However, since the display surface in the real space does not correspond to the display surface (the perspective projection screen) in the virtual space; perspective projection conversion cannot be performed in a correct manner, thereby causing distortion of the stereoscopic image that is viewable to the viewer.

### BRIEF DESCRIPTION OF THE DRAWINGS

FIG. 1 is a diagrammatic illustration of a stereoscopic image display device according to a first embodiment;

FIG. 2 is a diagram illustrating a configuration example of a display unit according to the first embodiment;

FIG. 3 is a schematic diagram illustrating a situation in which a viewer is viewing the display unit according to the first embodiment;

FIG. 4 is a diagram illustrating a functional configuration example of an image processor according to the first embodiment;

FIG. 5 is a schematic diagram illustrating an example of the posture of three-dimensional data in an initial state according to the first embodiment;

FIG. 6 is a schematic diagram illustrating an example of posture control of the three-dimensional data according to the first embodiment;

FIG. 7 is a flowchart for explaining an example of operations performed in the image processor according to the first embodiment;

FIG. 8 is a diagram illustrating a functional configuration example of the image processor according to a modification example of the first embodiment;

FIG. 9 is a diagram illustrating a functional configuration example of an image processor according to a second embodiment;

FIG. 10 is a flowchart for explaining an example of operations performed in the image processor according to the second embodiment;

FIG. 11 is a diagram illustrating a functional configuration example of an image processor according to a third embodiment;

FIG. 12 is a flowchart for explaining an example of operations performed in the image processor according to the third embodiment; and

FIG. 13 is a diagram illustrating an example for hardware configuration of the image processor.

### DETAILED DESCRIPTION

According to an embodiment, an image processing device includes a detector, a determiner, and a generator. The detector is configured to detect a real-space position of a viewer. The determiner is configured to determine a first relative position in a virtual space between the viewer and a display surface displaying a stereoscopic image based on the real-space position of the viewer, so that a particular site of the object to be displayed on the display surface faces the viewer in the virtual space. The generator is configured to generate the stereoscopic image by rendering a three-dimensional data of the object based on the first relative position.

Exemplary embodiments of an image processing device, an image processing method, a computer program product, and a stereoscopic image display device according to the invention are described below in detail with reference to the accompanying drawings. In a stereoscopic image display device according to each embodiment described below, it is possible to implement a 3D display method such as the integral imaging method (II method) or the multi-view method. Examples of the stereoscopic image display device include a television (TV) set, a personal computer (PC), a smartphone, or a digital photo frame that enables a viewer to view a stereoscopic image with the unaided eye. Herein, a stereoscopic image points to an image that includes a plurality of parallax images having mutually different parallaxes. The parallaxes represent the differences in vision resulting from the different directions of viewing. Meanwhile, in the embodiments, an image can either be a still image or be a dynamic picture image.

### First Embodiment

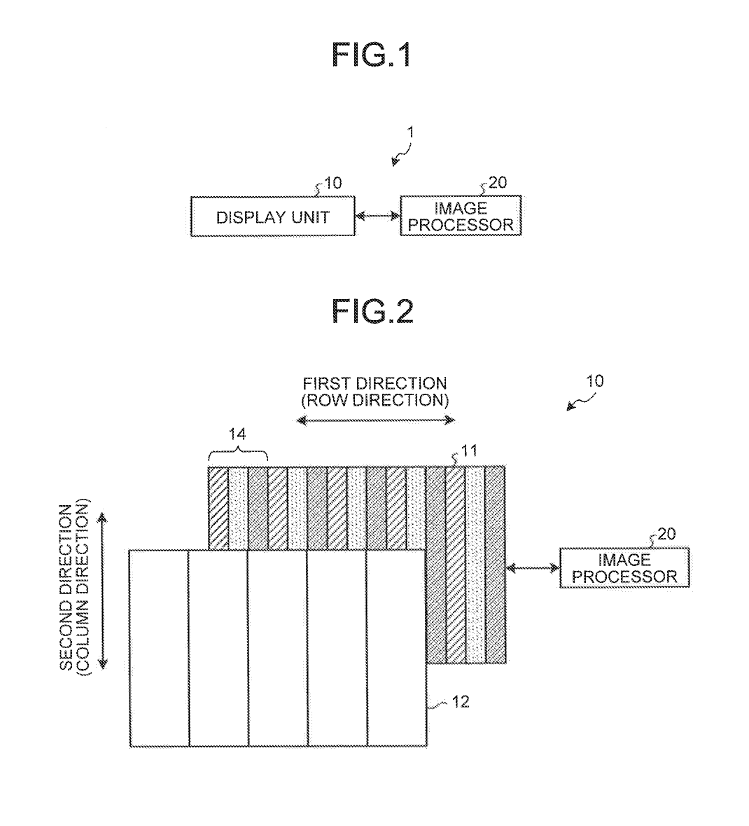

FIG. 1 is a diagrammatic illustration of a stereoscopic image display device 1 according to a first embodiment. As illustrated in FIG. 1, the stereoscopic image display device 1 includes a display unit 10 and an image processor 20.

FIG. 2 is a diagram illustrating a configuration example of the display unit 10. As illustrated in FIG. 2, the display unit 10 includes a display element 11 and an aperture controller 12. When a viewer views the display element 11 via the aperture controller 12, he or she becomes able to view the stereoscopic image being displayed on the display unit 10.

The display element 11 displays thereon the parallax images that are used in displaying a stereoscopic image. As far as the display element 11 is concerned, it is possible to use a direct-view-type two-dimensional display such as an organic electro luminescence (organic EL), a liquid crystal display (LCD), a plasma display panel (PDP), or a projection-type display. The display element 11 can have a known configuration in which, for example, a plurality of sub-pixels having red (R), green (G), and blue (B) colors is arranged in a matrix-like manner in a first direction (for example, the row direction with reference to FIG. 2) and a second direction (for example, the column direction with reference to FIG. 2). In the example illustrated in FIG. 2, a single pixel is made of RGB sub-pixels arranged in the first direction. Moreover, an image that is displayed on a group of pixels, which are adjacent pixels equal in number to the number of parallaxes and which are arranged in the first direction, is called an element image 14. Meanwhile, any other known arrangement of sub-pixels can also be adopted in the display element 11. Moreover, the sub-pixels are not limited to the three colors of red (R), green (G), and blue (B). Alternatively, for example, the sub-pixels can also have four colors.

The aperture controller 12 shoots the light beams, which are anteriorly emitted from the display element. 11, toward a predetermined direction via apertures (hereinafter, the apertures having such a function are called optical apertures). Examples of the aperture controller 12 include a lenticular sheet, a parallax barrier, and a liquid crystalline GRIN lens. The optical apertures are arranged corresponding to the element images of the display element 11.

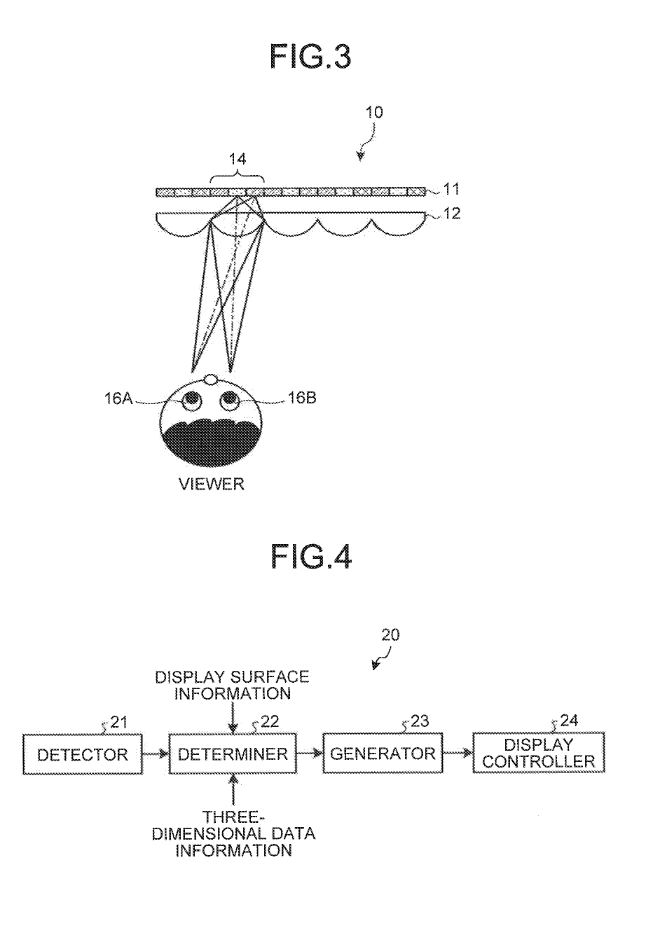

FIG. 3 is a schematic diagram illustrating a situation in which a viewer is viewing the display unit 10. When a plurality of element images 14 is displayed on the display element 11, a parallax image group corresponding to a plurality of parallax directions gets displayed (i.e., a multiple parallax image gets displayed) on the display element 11. The light beams coming out from this multiple parallax image pass through the optical apertures. Then, the pixels included in the element images 14 and viewed by the user with a left eye 16A are different than the pixels included in the element images 14 and viewed by the user with a right eye 16B. In this way, when images having different parallaxes are displayed with respect to the left eye 16A and the right eye 16B of the viewer, it becomes possible for the viewer to view stereoscopic images. Moreover, the range within which the viewer is able to view stereoscopic images is called the visible area.

In the first embodiment, the aperture controller 22 is disposed in such a way that the extending direction of the optical apertures thereof is consistent with the second direction (the column direction) of the display element 11. However, that is not the only possible case. Alternatively, for example, the configuration can be such that the aperture controller 12 is disposed in such a way that the extending direction of the optical apertures thereof has a predetermined tilt with respect to the second direction (the column direction) of the display element 11 (i.e., the configuration of a slanted lens).

Given below is the explanation about the image processor 20. Herein, the image processor 20 generates stereoscopic images to be displayed on the display unit 10. In this example, the image processor 20 corresponds to an “image processing device” mentioned in claims. FIG. 4 is a diagram illustrating a configuration example of the image processor 20. As illustrated in FIG. 4, the image processor 20 includes a detector 21, a determiner 22, a generator 23, and a display controller 24.

The detector 21 detects a real-space position of a viewer. In this example, the explanation is given for an example in which a marker (usable as a mark) attached to the head region of the viewer is detected using an infrared-light-based sensor (not illustrated). However, that is not the only possible case. In this example, the position of the marker detected based on the signals received from the sensor (not illustrated) is detected as the real-space position of the viewer (i.e., detected as the viewpoint position) by the detector 21. However, that is not the only possible case. Alternatively, for example, the detector 21 can make use of an image (a captured image) taken by a camera (such as a monocular camera) that captures a predetermined area in the real space and estimate the viewpoint position of the viewer who is appearing in the captured image, and then detect the estimated viewpoint position of the viewer as the position of the viewer in the real space.

Based on the position of the viewer detected by the detector 21, the determiner determines a first relative position in a virtual space (the virtual space is a space used in rendering three-dimensional data of an object to be viewed) between the viewer and a display surface (pointing to the surface of the display unit 10 on which stereoscopic images are displayed) displaying a stereoscopic image based on the real-space position of the viewer, so that a particular site of the object to be displayed on the display surface faces the viewer in the virtual space. More particularly, the first relative position represents the positional relationship among the position of the viewer, the three-dimensional data of the object, and the display surface in the virtual space. The more particular explanation is as given below. Herein, the three-dimensional data points to the data that enables expressing the shape of a three-dimensional object, and may contain a space division model or a boundary representation model of volume data. The space division model indicates a model in which, for example, the space is divided in a reticular pattern, and a three-dimensional object is expressed using the divided grids. The boundary representation model indicates a model in which, for example, a three-dimensional object is expressed by representing the boundary of the area covered by the three-dimensional object in the space. Meanwhile, the three-dimensional data, which is used in generating the stereoscopic image by the image processor 20, can be of any arbitrary type.

In the first embodiment, the position and the posture of the display surface in the virtual space is fixed in advance, and the position of the three-dimensional data in the virtual space is fixed in advance. The determiner 22 can obtain, from a memory (not illustrated) (or from an external device), display surface information indicating the size, the position, and the posture of the display surface in the virtual space; and three-dimensional data information indicating the position of the three-dimensional data in the virtual space and the posture of the three-dimensional data in the initial state. In this example, it is assumed that the front surface of the three-dimensional data corresponds to the “particular site”. Moreover, it is assumed that, when a viewer is present at a position from which the display surface is viewable from the front side, the posture of the three-dimensional data in the initial state is set in advance in such a way that the viewer can view the front surface of the three-dimensional data from the front side. Herein, the particular site can be set in an arbitrary manner. For example, any one of the right side surface, the left side surface, the upper surface, the lower surface, and the back surface of the three-dimensional data can be set as the particular site.

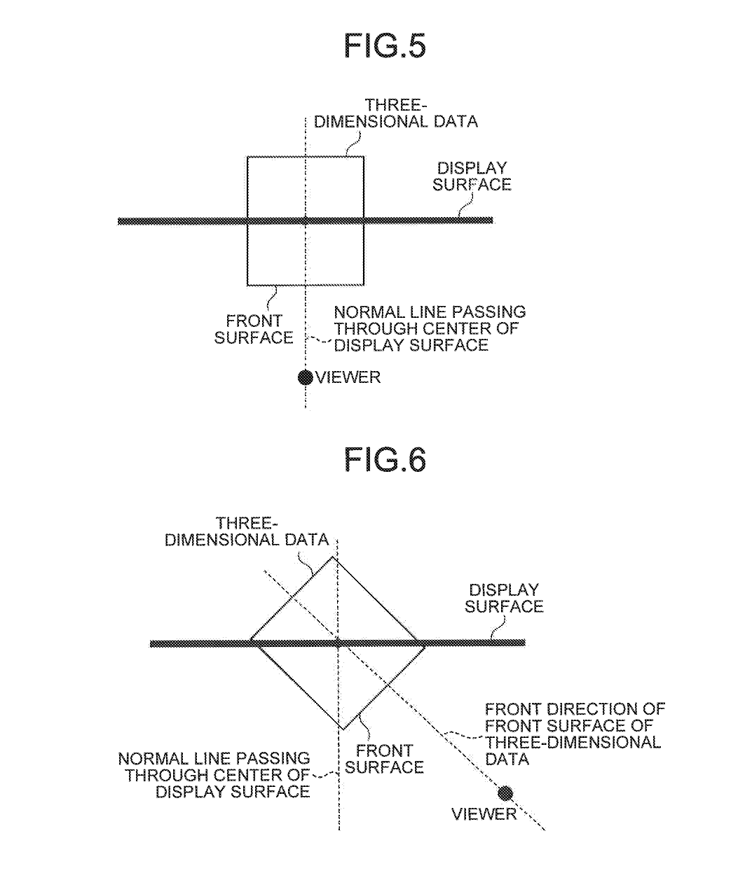

FIG. 5 is a schematic diagram illustrating an example of the posture of the three-dimensional data in the initial state. In the example illustrated in FIG. 5, in the virtual space, the center position (the position of the center of gravity) of the three-dimensional data is set in advance to match with the center position of the display surface; and the posture of the three-dimensional data in the initial state is set in advance in such a way that the normal direction of the front surface of the three-dimensional data matches with the normal direction of the display surface. That is, in the virtual space, the posture of the three-dimensional data in the initial state is set in advance in such a way that, when the viewer is present on the normal line passing through the center of the display surface as illustrated in FIG. 5 (i.e., when the viewer is present at a position from which the display surface is viewable from the front side), the viewer can view the front surface of the three-dimensional data from the front side.

Given below is the explanation of the determiner 22 with reference to FIG. 4. In the first embodiment, depending on the position of the viewer detected by the detector 21 (i.e., depending on the real-space position of the viewer), the determiner 22 obtains the position of the viewer in the virtual space and determines the posture of the three-dimensional data in such a way that the particular site of the three-dimensional data is oriented toward the obtained position of the viewer. In this example, the determiner 22 performs scale transformation and transforms the position of the viewer detected by the detector 21 into the position of the viewer in the virtual space. More particularly, the determiner 22 performs scale transformation by multiplying, with respect to the position of the viewer detected by the detector 21, the value of the ratio of the distance unit in the virtual space and the distance unit in the real space so that the distance units become identical to each other. Moreover, the determiner 22 can refer to the position of the viewer in the virtual space as obtained by performing scale transformation, and calculate the three-dimensional position of the left eye and the three-dimensional position of the right eye in the virtual space. For example, considering the position of the head region as the center, the position obtained by moving to the left by a certain amount and the position obtained by moving to the right by a certain amount can be calculated as the viewpoint position of the left eye and the viewpoint position of the right eye, respectively.

Then, the determiner 22 performs control to change the posture of the three-dimensional data from the posture in the initial state as specified in the three-dimensional data information so as to ensure that the front direction (e.g., the front surface) of the particular site of the three-dimensional data (i.e., the direction in which the particular site is viewable from the front side) is oriented toward the position of the viewer in the virtual space as obtained in the manner described above. For example, as illustrated in FIG. 6, even if the position of the viewer in the virtual space is not on the normal line passing through the center of the display surface (i.e., even if the position of the viewer in the virtual space does not enable viewing of the display surface from the front side), the determiner 22 performs control to change the posture of the three-dimensional data from the posture in the initial state illustrated in FIG. 5. In this example, the determiner 22 performs control to change the posture of the three-dimensional data by rotating the three-dimensional data around the position of the center of gravity of the three-dimensional data.

Given below is the explanation of the generator 23 with reference to FIG. 3. Based on the first relative position determined by the determiner 22, the generator 23 performs rendering of the three-dimensional data of the object and generates a stereoscopic image. In the first embodiment, with the display surface in the virtual space serving as the perspective projection screen, the generator 23 performs perspective projection of the three-dimensional data that has been subjected to posture control by the determiner 22, and generates a two-dimensional image for left eye (a parallax image for left eye) corresponding to the left eye viewpoint position in the virtual space and generates a two-dimensional image for right eye (a parallax image for right eye) corresponding to the right eye viewpoint position in the virtual space.

The display controller 24 performs control to display the stereoscopic image, which includes the two-dimensional image for left eye and the two-dimensional image for right eye generated by the generator 23, on the display unit 10.

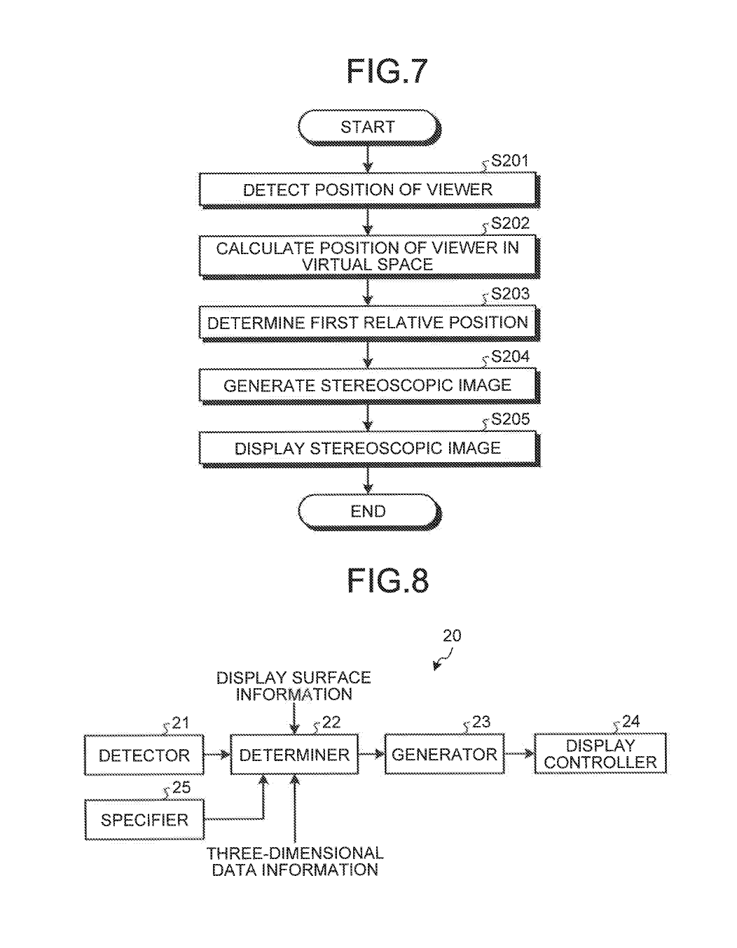

Given below is the explanation of an example of operations performed in the image processor 20 according to the first embodiment. FIG. 7 is a flowchart for explaining an example of operations performed in the image processor 20. As illustrated in FIG. 7, the detector 21 detects the real-space position of the viewer (Step S201). Then, depending on the position of the viewer detected at Step S201, the determiner 22 calculates the position of the viewer in the virtual space (Step S202). Subsequently, the determiner 22 determines the first relative position that represents the positional relationship among the position of the viewer, the three-dimensional data, and the display surface in the virtual space in such a way that the particular site of the three-dimensional data (for example, the front surface of the three-dimensional data) faces the position of the viewer in the virtual space obtained at Step S202 (Step S203). As described above, in the first embodiment, the position and the posture of the display surface in the virtual space is fixed in advance, and the position of the three-dimensional data in the virtual space is fixed in advance. Thus, the determiner 22 obtains the display surface information and the three-dimensional data information from a memory (not illustrated). Then, the determiner 22 performs control to change the posture of the three-dimensional data from the posture in the initial state as specified in the three-dimensional data information so as to ensure that the front direction of the front surface (an example of the particular site) of the three-dimensional data faces the position of the viewer in the virtual space as obtained at Step S202.

Then, based on the first relative position determined at Step S203, the generator 23 performs rendering of the three-dimensional data and generates a stereoscopic image (Step S204). Subsequently, the display controller 24 performs control to display the stereoscopic image, which is generated at Step S204, on the display unit 10 (Step S205).

As described above, in the first embodiment, the position and the posture of the display surface in the virtual space is fixed in advance, and the position of the three-dimensional data in the virtual space is fixed in advance. Depending on the position of the viewer detected by the detector 21 (i.e., depending on the real-space position of the viewer), the determiner 22 obtains the position of the viewer in the virtual space and controls the posture of the three-dimensional data in such a way that the particular site of the three-dimensional data (such as the front surface of the three-dimensional data) faces the obtained position of the viewer; and determines a first relative position among the position of the viewer, the three-dimensional data, and the display surface in the virtual space. Then, a stereoscopic image is obtained by rendering the three-dimensional data based on the first relative position; and the stereoscopic image is displayed on the display unit 10. Hence, regardless of the current position of the viewer, he or she becomes able to stereoscopically view the particular site of the three-dimensional data from the front side. Besides, the stereoscopic images viewable to the viewer are not distorted too. Thus, according to the first embodiment, the viewable posture remains the same regardless of the position of viewing, and undistorted stereoscopic images can be presented. The configurations according to the embodiments herein are preferable for applications such as CAD, medical images, and work training, for which representations without ruining the actual depth are wanted.

### First Modification Example of First Embodiment

The three-dimensional data is variable size, and the determiner 22 can set a size of the three-dimensional data so that the object is stereoscopically displayed in entirety.

For example, when the object, is stereoscopically displayed, the determiner sets the size of the three-dimensional data to a displayable size that avoids ruining the depth of the object.

For example, in the case when the three-dimensional data cannot be displayed in entirety by performing perspective projection conversion at Step S204 illustrated in FIG. 7; the determiner 22 can scale down the three-dimensional data in such a way that the entirety of projection screen of the object is included in the two-dimensional image for left eye as well as in the two-dimensional image for right eye. This allows prevention of a situation in which some portion of projection screen of the object to be viewed cannot be viewed depending on the viewpoint position.

### Second Modification Example of First Embodiment

In a stereoscopic image display device, there is a restriction on the depth up to which correct stereoscopic display can be performed. For example, in a stereoscopic image display device, there is a restriction that, with respect to the display surface in the virtual space, stereoscopic display can be correctly performed only in an area in the far side corresponding to a predetermined threshold value and an area in the near side corresponding to a predetermined threshold value. For example, the depth of the three-dimensional data can be set to be within a stereoscopic display limit range which indicates the range in the depth direction (the normal direction) of the display surface in which stereoscopic images can be stereoscopically viewed. For example, at Step S203 illustrated in FIG. 7, the determiner 22 calculates the upper limit and the lower limit of the three-dimensional data. If those values are not within the stereoscopic display limit range, the determiner 22 can scale down the depth of the three-dimensional data in such a way that the upper limit and the lower limit of the depth of the three-dimensional data are within the stereoscopic display limit range. With that, it becomes possible to prevent a situation in which the object to be viewed cannot be stereoscopically viewed depending on the size of the three-dimensional data or depending on the viewpoint position. Meanwhile, the stereoscopic display limit range is a parameter determined according to the specifications and the standard of the display unit 10. Moreover, the stereoscopic display limit range can be stored in a memory (not illustrated) in the stereoscopic image display device 1, or can be stored in an external device.

### Third Modification Example of First Embodiment

For example, as illustrated in FIG. 8, the image processor 20 can further include a specifier 25 that, according to an input, specifies any one site of the three-dimensional data as the particular site. Then, the determiner 22 can determine, in the virtual space, the first relative position in such a way that the particular site specified by the specifier 25 faces the position of the viewer in the virtual space.

For example, specifiable particular sites can be fixed in advance. For example, if the front surface of the three-dimensional data is considered to be a first particular site candidate pattern, the right side surface of the three-dimensional data is considered to be a second particular site candidate pattern, and the left side surface of the three-dimensional data is considered to be a third particular site candidate pattern; then the viewer can perform input to instruct selection of any one of the three particular site candidate patterns. Then, according to the selection instruction input by the viewer, the specifier 25 can specify one of the three particular site candidate patterns. With that, the viewer can view stereoscopic images while switching the particular site. Meanwhile, the type and the number of particular site candidate patterns can be changed in an arbitrary manner.

Alternatively, for example, specifiable particular sites may not be fixed in advance. For example, when an input for specifying the particular site is received, the specifier 25 can specify such a site of the three-dimensional data in the virtual space which faces the current position of the viewer in the virtual space as the particular site. For example, the viewer can possess an ON/OFF switch for performing an input for specifying the particular site and can turn ON the ON/OFF switch to perform an input for specifying the particular site. With that, the viewer can select the particular site with more freedom.

In case the particular site is not specified (for example, if the ON/OFF switch is OFF), the determiner 22 obtains the position of the viewer in the virtual space according to the position of the viewer detected by the detector 21 (i.e., according to the position of the viewer in the real space) but does not control the posture of the three-dimensional data. That is, in this case, with the display surface in the virtual space serving as the perspective projection screen, the three-dimensional data having the posture in the initial state is subjected to perspective projection conversion so that a two-dimensional image for left eye corresponding to the left eye viewpoint position in the virtual space and a two-dimensional image for right eye corresponding to the right eye viewpoint position in the virtual space are generated and displayed on the display unit 10. In this case, although the posture of the three-dimensional data to be stereoscopically viewed remains the same as in the initial state, the stereoscopic image viewable to the viewer does not get distorted.

### Second Embodiment

Given below is the explanation of a second embodiment. Herein, as compared to the first embodiment, the second embodiment differs in the way that the position of the viewer in the virtual space is set (fixed) in advance. The details are explained below. Meanwhile, the explanation regarding the contents identical to the first embodiment is not repeated.

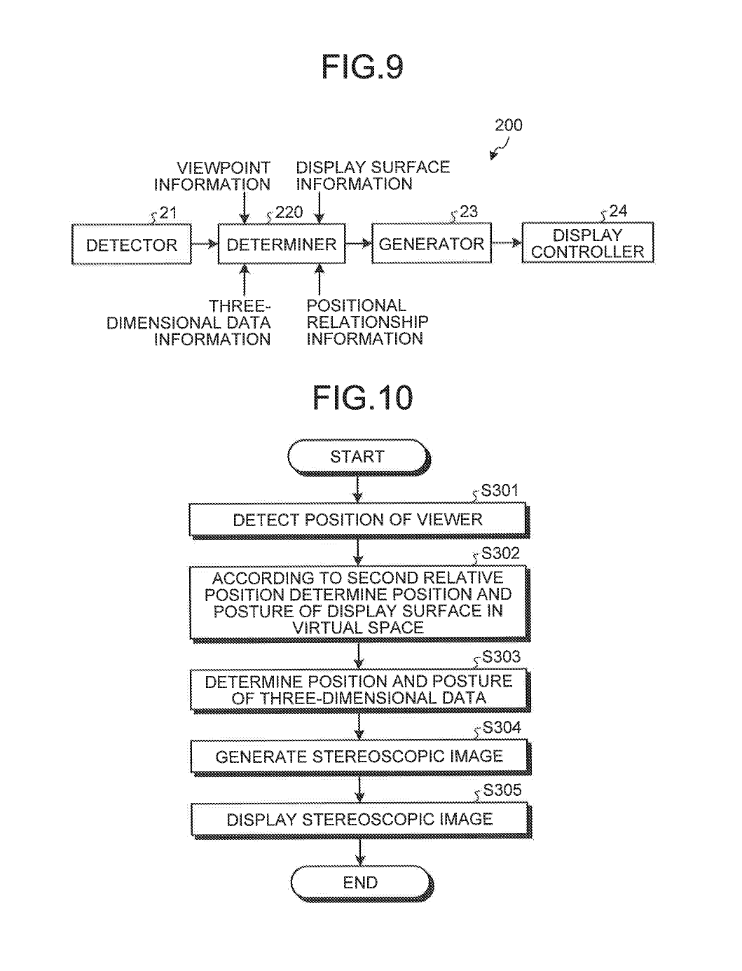

FIG. 9 is a diagram illustrating a configuration example of an image processor 200 according to the second embodiment. As illustrated in FIG. 9, the image processor 200 includes the detector 21, a determiner 220, the generator 23, and the display controller 24. The determiner 220 can obtain, from a memory (not illustrated) (or from an external device), viewpoint information indicating the position of the viewer (a fixed value) in the virtual space; display surface information indicating the size of the display surface in the virtual space, and the position and the posture of the display surface in the initial state; three-dimensional data information indicating the three-dimensional data; and positional relationship information indicating a relative position (a third relative position) between the display surface and the three-dimensional data that is predefined. The following explanation is given with the focus on the functions of the determiner 220.

Depending on the position of the viewer detected by the detector 21 (i.e., the position of the viewer in the real space), the determiner 220 obtains a second relative position between the position of the viewer and the display surface in the real space. Herein, the second relative position between the real-space position of the viewer and the display surface in the real space can be expressed, for example, using the angle between the front direction of the display surface and the line of sight with respect to the display surface from the position of the viewer (for example, the angle between the normal direction passing through the center of the display surface and the line of sight from the position of the viewer toward the center of the display surface), or using the distance between the display surface and the position of the viewer. Based on the second relative position, the viewpoint information, and the display surface information; the determiner 220 determines the position and the posture of the display surface in the virtual space. Then, the determiner 220 determines the position of the three-dimensional data in the virtual space by referring to the third relative position specified in the positional relationship information; and controls the posture of the three-dimensional data in the virtual space in such a way that, in the virtual space, the particular site of the three-dimensional data faces the position of the viewer in the virtual space. In this way, the determiner 220 determines the first relative position among the position of the viewer, the three-dimensional data, and the display surface in the virtual space.

Given below is the explanation of an example of operations performed in the image processor 200 according to the second embodiment. FIG. 10 is a flowchart for explaining an example of operations performed in the image processor 200. As illustrated in FIG. 10, the detector 21 detects the real-space position of the viewer (Step S301). Then, the determiner 220 obtains the second relative position, which represents a relative positional relationship between the position of the viewer and the display surface in the real space, according to the position of the viewer detected at Step S301; and determines the position and the posture of the display surface in the virtual space according to the second relative position (Step S302). Subsequently, the determiner 220 refers to the abovementioned third relative position specified in the positional relationship information and determines the position of the three-dimensional data in the virtual space; and controls the posture of the three-dimensional data in the virtual space in such a way that the front direction of the particular site of the three-dimensional data faces the position of the viewer in the virtual space. With that, the determiner 220 determines the position and the posture of the three-dimensional data in the virtual space (Step S303). In this way, the determiner 220 determines the first relative position that represents the positional relationship among the position of the viewer, the three-dimensional data, and the display surface in the virtual space.

Then, based on the first relative position determined by the determiner 220, the generator 23 performs rendering of the three-dimensional data and generates a stereoscopic image (Step S304). Subsequently, the display controller 24 performs control to display the stereoscopic image, which is generated at Step S304, on the display unit 10 (Step 3305).

Thus, in the second embodiment too, in an identical manner to the first embodiment, the viewable posture remains the same regardless of the position of viewing, and undistorted stereoscopic images can be presented.

### Third Embodiment

Given below is the explanation of a third embodiment. As compared to the embodiments described above, the third embodiment differs in the way that the position and the posture of the three-dimensional data in the virtual space are set (fixed) in advance. The details are explained below. Meanwhile, the explanation regarding the contents identical to the embodiments described above is not repeated.

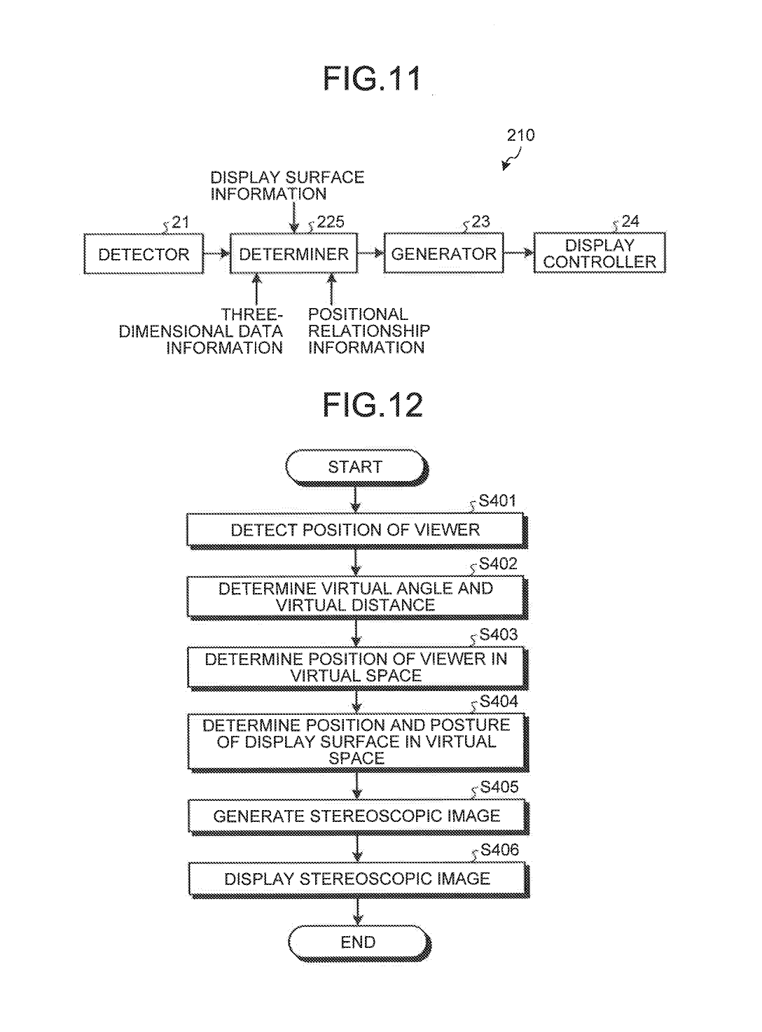

FIG. 11 is a diagram illustrating a configuration example of an image processor 210 according to the third embodiment. As illustrated in FIG. 11, the image processor 210 includes the detector 21, a determiner 225, the generator 23, and the display controller 24. The determiner 225 can obtain, from a memory (not illustrated) (or from an external device), display surface information indicating the size of the display surface in the virtual space, and the position and the posture of the display surface in the initial state; three-dimensional data information indicating the position and the posture of the three-dimensional data in the virtual space; and positional relationship information indicating a relative position (the third relative position) between the display surface and the three-dimensional data that is predefined. The following explanation is given with the focus on the functions of the determiner 225.

According to the position of the viewer detected by the detector 21, the determiner 220 obtains the second relative position that represents a relative positional relationship between the position of the viewer and the display surface in the real space. Then, according to the second relative position, the determiner 225 determines (calculates) a virtual angle, which represents the angle between the front direction of the display surface in the virtual space and the line of sight with respect to the display surface from the position of the viewer (for example, the angle between the normal direction passing through the center of the display surface and the line of sight from the position of the viewer toward the center of the display surface), and calculates a virtual distance, which represents the distance between the display surface and the position of the viewer in the virtual space.

Moreover, the determiner 225 determines the position of the viewer in the virtual space in such a way that, in the virtual space, the particular site of the three-dimensional data faces the position of the viewer and the distance between the three-dimensional data and the position of the viewer is equal to the virtual distance mentioned above. Furthermore, the determiner 225 refers to the third relative position specified in the positional relationship information and determines the position of the display surface in the virtual space. Then, the determiner 225 determines the posture of the display surface in the virtual space according to the virtual angle mentioned above. More particularly, the determiner 225 determines the posture of the display surface in the virtual space to be equal to the posture tilted by the virtual angle. In this way, the determiner 225 determines the first relative position that represents the positional relationship among the position of the viewer, the three-dimensional data, and the display surface in the virtual space.

Given below is the explanation of an example of operations performed in the image processor 210 according to the third embodiment. FIG. 12 is a diagram illustrating a flowchart for explaining an example of operations performed in the image processor 210. As illustrated in FIG. 12, the detector 21 detects the real-space position of the viewer (Step 3401). Then, the determiner 225 obtains the second relative position according to the position of the viewer detected at Step S401, and determines the virtual angle and the virtual distance according to the second relative position (Step S402).

Subsequently, the determiner 225 determines the position of the viewer in the virtual space in such a way that, in the virtual space, the front direction of the particular site of the three-dimensional data faces the position of the viewer and the distance between the three-dimensional data and the position of the viewer is equal to the virtual distance mentioned above (Step S403). Then, the determiner 225 refers to the third relative position between the display surface and the three-dimensional data as specified in the positional relationship information and determines the position of the display surface in the virtual space, and determines the posture of the display surface in the virtual space to be equal to the posture tilted by the virtual angle (Step S404). In this way, the determiner 225 determines the first relative position that represents the positional relationship among the position of the viewer, the three-dimensional data, and the display surface in the virtual space.

Subsequently, based on the first relative position determined by the determiner 225, the generator 23 performs rendering of the three-dimensional data and generates a stereoscopic image (Step S405). Then, the display controller 24 performs control to display the stereoscopic image, which is generated at Step S405, on the display unit 10 (Step 406).

In this way, in the third embodiment too, in an identical manner to the embodiments described above, the viewable posture remains the same regardless of the position of viewing, and undistorted stereoscopic images can be presented.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

In the explanation given above, an unaided-eye-type stereoscopic image display device is taken an as example of the stereoscopic image display device in which the invention is implemented. However, that is not the only possible case. Alternatively, for example, it is also possible to use a glasses-type stereoscopic image display device.

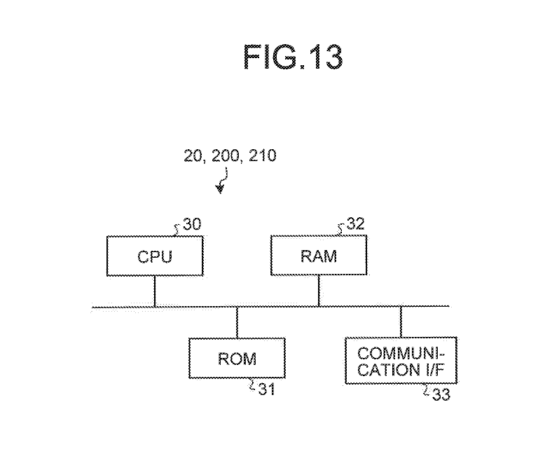

For the hardware configurations of the image processors (20, 200, 210) in the aforementioned embodiments, hardware configurations for general computers may be employed that include a CPU 30, a ROM 31, a RAM 32, and a communication interface (I/F) 33 as illustrated in FIG. 13. Each function of the aforementioned image processors (20, 200, 210) may be implemented by executing a program stored in the ROM 31 by running the program on the RAM 32 by the CPU 30.

However, that is not the only possible case. Alternatively, at least some of the functions of the constituent elements can be implemented using a dedicated hardware circuit. For example, the detector 21, the determiner (22, 220, 225), and the generator 23 included in the aforementioned image processors (20, 200, 210) may be each configured from a semiconductor integrated circuit.

Meanwhile, the computer programs executed in the image processors (the image processor 20, the image processor 200, and the image processor 210) can be saved as downloadable files on a computer connected to the Internet or can be made available for distribution through a network such as the Internet. Alternatively, the computer programs executed in the image processors (the image processor 20, the image processor 200, and the image processor 210) may be stored in advance in a nonvolatile storage medium such as a ROM, and provided as a computer program product.

Moreover, the embodiments and the modification examples explained above can be combined in an arbitrary manner.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device, comprising:
a detector configured to detect a real-space position of a viewer;
a determiner configured to determine a first relative position in a virtual space between the viewer and a display surface displaying a stereoscopic image based on the real-space position of the viewer, so that a particular site of the object to be displayed on the display surface faces the viewer in the virtual space; and
a generator configured to generate the stereoscopic image by rendering a three-dimensional data of the object based on the first relative position.

2. The device according to claim 1, wherein
a position and an posture of the display surface in the virtual space, and a position of the three-dimensional data are predetermined, and
the determiner determines the first relative position by obtaining the position of the viewer in the virtual space according to the real-space position of the viewer, and a posture of the three-dimensional data.

3. The device according to claim 2, wherein the three-dimensional data is a variable size, and the determiner sets a size of the three-dimensional data so that the object is stereoscopically displayed in entirety.

4. The device according to claim 3, wherein when the object is stereoscopically displayed, the determiner sets the size of the three-dimensional data to a displayable size that avoids ruining depth of the object.

5. The device according to claim 2, wherein the determiner sets depth of the three-dimensional data in a variable manner such that the depth of the three-dimensional data is within a stereoscopic display limit range that indicates a range in a depth direction of the display surface in which the stereoscopic image is stereoscopically viewable.

6. The device according to claim 2, further comprising a specifier configured to specify any one site of the three-dimensional data as the particular site.

7. The device according to claim 6, wherein the specifier specifies a site of the three-dimensional data in the virtual space that faces the current position of the viewer in the virtual space when receiving an input for specifying the particular site.

8. The device according to claim 1, wherein
the position of the viewer in the virtual space is predetermined,
the determiner obtains a second relative position between the real-space position of the viewer and the display surface in the real space, according to the real-space position of the viewer, and determines a position and a posture of the display surface in the virtual space according to the second relative position, and
the determiner determines a position of the three-dimensional data in the virtual space by referring to a third relative position between the display surface and the three-dimensional data that is predefined, and determines a posture of the three-dimensional data in the virtual space so that the particular site faces the viewer in the virtual space.

9. The device according to claim 1, wherein
a position and a posture of the three-dimensional data in the virtual space are predetermined,
the determiner obtains a second relative position between the real-space position of the viewer and the display surface in the real space, according to the real-space position of the viewer, and
determines a virtual angle that represents an angle between a front direction of the display surface in the virtual space and a line of sight with respect to the display surface from the position of the viewer, and a virtual distance that represents a distance between the display surface and the position of the viewer in the virtual space, according to the second relative position,
the determiner determines the position of the viewer in the virtual space so that the particular site faces the viewer in the virtual space and that a distance between the three-dimensional data and the position of the viewer is equal to the virtual distance, and
the determiner determines a position of the display surface in the virtual space by referring to a third relative position between the display surface and the three-dimensional data that is predefined, and determines a posture of the display surface in the virtual space according to the virtual angle.

10. The device according to claim 1, wherein
the detector, the determiner, the generator are implemented as a processor.

11. An image processing method, comprising:
detecting a real-space position of a viewer;
determining a first relative position in a virtual space between the viewer and a display surface displaying a stereoscopic image based on the real-space position of the viewer, so that a particular site of the object to be displayed on the display surface faces the viewer in the virtual space; and
generating the stereoscopic image by rendering the three-dimensional data of the object based on the first relative position.

12. A stereoscopic image display device, comprising:
a image processor according to claim 1; and
display unit to display the stereoscopic image on the display surface.

13. The device according to claim 12, wherein
a position and a posture of the display surface in the virtual space, and a position of the three-dimensional data are predetermined, and
the determiner determines the first relative position by obtaining the position of the viewer in the virtual space according to the real-space position of the viewer, and a posture of the three-dimensional data.

14. The device according to claim 13, wherein the three-dimensional data is a variable size, and the determiner sets a size of the three-dimensional data so that the object is stereoscopically displayed in entirety.

15. The device according to claim 14, wherein when the object is stereoscopically displayed, the determiner sets the size of the three-dimensional data to a displayable size that avoids ruining depth of the object.

16. The device according to claim 13, wherein the determiner sets depth of the three-dimensional data in a variable manner such that the depth of the three-dimensional data is within a stereoscopic display limit range that indicates a range in a depth direction of the display surface in which the stereoscopic image is stereoscopically viewable.

17. The device according to claim 13, further comprising a specifier configured to specify any one site of the three-dimensional data as the particular site.

18. The device according to claim 17, wherein the specifier specifies a site of the three-dimensional data in the virtual space that faces the current position of the viewer in the virtual space when receiving an input for specifying the particular site.

19. The device according to claim 12, wherein
the position of the viewer in the virtual space is predetermined,
the determiner obtains a second relative position between the real-space position of the viewer and the display surface in the real space, according to the real-space position of the viewer, and determines a position and a posture of the display surface in the virtual space according to the second relative position, and
the determiner determines a position of the three-dimensional data in the virtual space by referring to a third relative position between the display surface and the three-dimensional data, and determines a posture of the three-dimensional data in the virtual space so that the particular site faces the viewer in the virtual space.

20. The device according to claim 12, wherein
a position and a posture of the three-dimensional data in the virtual space are predetermined,
the determiner obtains a second relative position between the real-space position of the viewer and the display surface in the real space, according to the real-space position of the viewer, and
the determiner determines a virtual angle that represents an angle between a front direction of the display surface in the virtual space and a line of sight with respect to the display surface from the position of the viewer, and a virtual distance that represents a distance between the display surface and the position of the viewer in the virtual space, according to the second relative position,
the determiner determines the position of the viewer in the virtual space so that the particular site faces the viewer in the virtual space and that a distance between the three-dimensional data and the position of the viewer is equal to the virtual distance, and
the determiner determines a position of the display surface in the virtual space by referring to a third relative position between the display surface and the three-dimensional data, and determines a posture of the display surface in the virtual space according to the virtual angle.
